(19) United States
(12) Patent Application Publication
(10) Pub. No.: US 2009/0176917 A1
(43) Pub. Date: Jul. 9, 2009

(54) THERMOPLASTIC PLASTIC MATERIALS, PARTICULARLY POLYURETHANE, CONTAINING POLYTETRAHYDROFURAN-ESTER AS A SOFTENING AGENT

(75) Inventors: Günter Lübker, Brockum (DE); Clemens Thesing, Twistringen (DE); Frank Schäfer, Stemwede (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf SE, Ludwigshafen (DE)

(21) Appl. No.: 12/296,946

(22) PCT Filed: Apr. 11, 2007
(86) PCT No.: PCT/EP07/53508

§ 371 Date: Oct. 13, 2008

(30) Foreign Application Priority Data
Apr. 18, 2006 (EP) 06112708.0

(51) Int. Cl. C08K 5/10

(52) U.S. Cl. 524/292

(57) ABSTRACT

Thermoplastics comprising plasticizer (i), wherein the plasticizer (i) is an ester based on polytetrahydrofuran and on a monocarboxylic acid.

The present invention relates to thermoplastics, preferably thermoplastic polyurethanes comprising plasticizer (i), where the plasticizer (i) is an ester based on polytetrahydrofuran and on a monocarboxylic acid, preferably benzoic acid. The invention further relates to processes for the production of thermoplastic polyurethanes preferably via reaction of (a) Isocyanates with (b) compounds which are reactive toward isocyanates and whose molar mass is from 500 g/mol to 10 000 g/mol, and, if appropriate, (c) chain extenders whose molar mass is from 50 g/mol to 499 g/mol, if appropriate in the presence of (d) catalysts, and/or of (e) conventional auxiliaries, where the inventive plasticizers (i) are added to the thermoplastic polyurethane during and/or after the production process, preferably during and/or after the reaction of the isocyanates (a) with the compounds which are reactive toward isocyanates and whose molar mass is from 500 g/mol to 10 000 g/mol, and, if appropriate, with (c) chain extenders whose molar mass is from 50 g/mol to 499 g/mol.

Thermoplastic polyurethanes, hereinafter also termed TPUs, are plastics with a wide field of applications. TPUs are by way of example formed in the automobile industry, e.g. in instrument panel skins, in films, in cable sheathing, in the leisure industry, in the form of heel lifts, in the form of functional and design elements for sports shoes, or in the form of a soft component in hard/soft combinations.

The hardness of TPUs is usually from 80 Shore A to 74 Shore D. However, many of the abovementioned applications require a hardness level below 80 Shore A. For this reason, plasticizers which can lower Shore hardness are added to TPUs in the prior art. Examples of familiar plasticizers are benzoates, phthalates, and phosphoric esters.

When the plasticizer is selected it is preferable to take care that the product is compatible with the TPU. In this context, compatible means that the plasticizer must be capable of admixture with the TPU during the processes usually used for TPU production, and that the plasticizer subsequently remains very substantially permanently within the product, and is not lost via exudation or evaporation. The mechanical properties of the TPU, e.g. abrasion and elastomeric properties, should moreover not be impaired. Many plasticized TPUs are destined for applications which also have exposure to sunlight, examples being design elements in the shoe industry. Here, it is disadvantageous if the plasticizer contributes to yellowing of the product through UV degradation.

EP 1 106 634 describes a polyurethane plasticizer based on a polyether prepolymer whose NCO content is <13%, which has been reacted with a monoalcohol. The problem with this type of plasticizer production is the residual monomer content of the prepolymer. These residual monomers react with the monoalcohol to give a diurethane, which is incompatible with TPU and can effloresce in the form of a white deposit. Furthermore, a urethane bond is capable of reversible thermal cleavage, and a plasticizer which contains a urethane bond therefore leads, via thermal degradation, to molar mass degradation of the polyurethane to be plasticized, and thus to a reduction in the level of mechanical properties.

U.S. Pat. No. 3,956,221 describes the production of compact, hard crosslinked polyurethanes in the presence of polyethers based on ethylene oxide and propylene oxide in the ratio 50:50, where the polyether has, as end-cap, an alkyl group having from 1 to 6 carbon atoms. The alkylation of polyethers is known from U.S. Pat. No. 2,782,240.

JP 2001-323043 describes a method for the production of plasticizers for polyurethanes, where alkoxypolyalkylene glycols and isocyanate are compounded. The alkoxypolyalkylene ether complies with the general formula RO(R₁O)ₘ(R₂O)ₙ H, where n=from 1 to 50, and m=from 0 to 20. R₁ here is an ethyl group and R₂ is a radical other than an ethyl group, e.g. a propyl or butyl radical.

JP 2001-342340 describes a polyurethane powder for slush applications and its method of production, comprising a pulverulent polyurethane and a plasticizer composed of an alkoxy poly(oxyalkylene) glycol and a molar mass from 100 to 1000 and an organic diisocyanate.

The object of the present invention therefore consisted in developing a plasticized thermoplastic, in particular a plasticized thermoplastic polyurethane, where the plasticizer used is easy to incorporate, does not exude, and is not lost by evaporation, and at the same time improves the properties of the plastic, such as processability, heat resistance, and UV resistance. The plasticizer should moreover not promote degradation of the thermoplastic.

The object was achieved via the thermoplastics described in the introduction, comprising the plasticizers (i).

The inventive plasticizers provide the following advantages in particular in thermoplastic polyurethanes:
Plasticizers based on benzoic esters are markedly less toxicologically hazardous than the corresponding phthalic esters
In comparison with known benzoic esters, volatility of the inventive plasticizers is lower, in particular in the case of those whose molar mass is from 300 to 4500 g/mol
A feature of the inventive plasticizers is good compatibility in the TPU (200% swelling)
In comparison with the known benzoic esters, e.g. Benzoflex TPU 405 and dipropylene glycol dibenzoate (CAS: 27138-31-4) the inventive plasticizers are less hygroscopic and therefore have processing advantages

The molar mass of the compound (i) is preferably from 300 g/mol to 4500 g/mol, particularly preferably from 300 g/mol to 2500 g/mol, in particular from 300 g/mol to 1500 g/mol. By virtue of its property, the compound (i) is also termed “plasticizer” in this specification.

Polytetrahydrofurans (also termed PTHF in this specification) are polyols prepared from tetrahydrofuran via cationic polymerization. Polytetrahydrofuran is well known and is commercially available with various molecular weights from BASF Aktiengesellschaft. The plasticizer (i) is preferably based on PTHF whose molar mass is from 162 g/mol to 4000 g/mol.

The monocarboxylic acids used to prepare the plasticizer (i) can be well-known monocarboxylic acids, for example acetic acid, formic acid, propionic acid, butyric acid, valeric acid, methylbenzoic acid, preferably acetic acid and/or benzoic acid, particularly preferably benzoic acid.

The plasticizer (i) therefore particularly preferably has the following structure:
H₅C₆—CO—O—[(CH₂)₄—O]ₙ—CO—C₆H₅
   where n is a whole number from the range from 2 to 50, preferably from 2 to 14.

One particular advantage in the use of the inventive molecules (i) as plasticizer is obtained when the compounds (i) are liquid at room temperature, i.e. at 25° C., and at a pressure of 1 bar.

The inventive plasticizer can be prepared via esterification of polytetrahydrofuran with a monocarboxylic acid, preferably benzoic acid. Processes of this type for the esterification of a polyether with a monocarboxylic acid are well known and widely described. The reaction of the polytetrahydrofuran with the carboxylic acid to give the plasticizer (i) can preferably be carried out by heating the polytetrahydrofuran with a stoichiometric amount of carboxylic acid, for example, with the anhydride or the acyl chloride of the carboxylic acid and an amount of carboxylic acid or carboxylic acid derivative which corresponds to from 10% by weight to 100% by weight of the stoichiometric amount of the carboxylic acid, in a reactor, preferably with exclusion of oxygen, e.g. under nitrogen, to from 110° C. to 160° C., preferably from 120 to 140° C., and then preferably adding transesterification catalyst. The expression stoichiometric amount means the molar amount corresponding to the molar amount of hydroxy groups of the polytetrahydrofuran. The transesterification catalyst used can be well-known transesterification catalysts, e.g. tin catalysts, e.g. dibutyltin dilaurate or tin dioctoate, titanium compounds, such as titanium tetrabutoxide, or a sulfonic acid, such as toluenesulfonic acid. Tin dioctoate is preferred. The usual amounts added of tin dioctoate are from 1 ppm to 1000 ppm, preferably from 5 ppm to 200 ppm, in particular from 20 ppm to 100 ppm. After the reaction is complete, the excess carboxylic acid can be removed from the plasticizer (i) by distillation.

Particular preference is given to plasticizers (i) in which the number-average molar mass is smaller than the weight-average molar mass. This reduces the tendency of the product toward crystallization.

The viscosity of the plasticizer (i) measured to ISO 3219 at 60° C. is preferably from 1 mPas to 100 000 mPas, preferably from 10 mPas to 10 000 mPas, in particular from 100 mPas to 1000 mPas.

The plasticizers (i) generally have a low hydroxy number by virtue of the reaction of the terminal hydroxy group(s). The hydroxy number of the plasticizers (i) is preferably smaller than 25 mg KOH/g, particularly preferably smaller than 5 mg KOH/g, in particular smaller than 2 mg KOH/g. A small OH number guarantees that the plasticizer has no effect on the stoichiometry of the urethane reaction.

The plasticizers (i) preferably have a low acid number smaller than 10, particularly preferably smaller than 0.5, in particular smaller than 0.05. A low acid number guarantees that hydrolysis, in particular the hydrolysis of the ester urethanes, is not adversely affected by the plasticizer.

The haze number of the intrinsic color of the inventive plasticizers is preferably smaller than 200, particularly preferably smaller than 50, in particular smaller than 30. This guarantees that the TPU has a low level of intrinsic color.

The alkali metal content of the plasticizers (i) is preferably smaller than 500 ppm, particularly preferably smaller than 15 ppm, in particular smaller than 5 ppm.

The water content of the inventive plasticizers is usually smaller than 0.2% by weight, preferably smaller than 0.05% by weight, particularly preferably smaller than 0.02% by weight. Excessive water content leads to foaming of the products on addition of isocyanate, to undesired formation of urea, and to a lower level of mechanical properties.

The inventive thermoplastic polyurethanes comprising the plasticizer (i) can preferably be produced via reaction of (a) isocyanates with (b) compounds reactive toward isocyanates and having a molar mass of from 500 g/mol to 10 000 g/mol and, if appropriate, (c) chain extenders having a molar mass of from 50 g/mol to 499 g/mol, if appropriate in the presence of (d) catalysts, and/or of (e) conventional auxiliaries, where the inventive plasticizers are added to the thermoplastic polyurethane during and/or after the production process, preferably during and/or after the reaction of the isocyanates (a) with the isocyanate-reactive compounds having a molar mass of from 500 g/mol to 10 000 g/mol and, if appropriate, (c) chain extenders having a molar mass of from 50 g/mol to 499 g/mol. The plasticizer therefore can be fed into at least one of the starting materials before production of the TPUs is complete, or else can be mixed with previously produced TPU, e.g. in a conventional extruder. The plasticizer can be incorporated into the thermoplastic by a swelling process. It is also possible for the plasticizer to be in the form of a concentrate in a thermoplastic and for the concentrate to be incorporated into the thermoplastic.

The Shore hardness of the thermoplastic polyurethane comprising the compound (i) is preferably from 40 Shore A to 95 Shore A.

The amount of the inventive compounds (i) comprise in the thermoplastic, preferably in the thermoplastic polyurethane, is from 1 to 70% by weight, particularly preferably from 5 to 40% by weight, in particular from 10 to 25% by weight, based in each case on the total weight of the thermoplastic comprising the plasticizer (i).

Processes for production of TPU are well known. By way of example, the thermoplastic polyurethanes can be produced via reaction of (a) isocyanates with (b) compounds reactive toward isocyanates and having a molar mass of from 500 g/mol to 10 000 g/mol and, if appropriate, (c) chain extenders having a molar mass of from 50 g/mol to 499 g/mol, if appropriate in the presence of (d) catalysts, and/or of (e) conventional auxiliaries and/or additives. The inventive plasticizers (i) can be added either to the compounds (b) reactive toward isocyanates prior to or during the production of the TPUs or else to the finished TPU, for example to the molten or softened TPU. The thermoplastic polyurethane can be processed thermoplastically, without loss of the action of the inventive plasticizers. The starting components and processes for production of the preferred TPUs will be described below. The components (a), (b), (c), and also, if appropriate, (d) and/or (e) usually used in the production of the TPUs will be described by way of example below:
a) Organic isocyanates (a) which may be used are well-known aliphatic, cyclo-aliphatic, araliphatic, and/or aromatic isocyanates, for example tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethyl-cyclohexane (isophorone diisocyanate, IPDI), 1,4- and/or 1,3-bis(isocyanato-methyl)cyclohexane (HXDI), cyclohexane 1,4-diisocyanate, 1-methylcyclohexane 2,4- and/or 2,6-diisocyanate and/or dicyclohexylmethane 4,4′-, 2,4′-, and 2,2′-diisocyanate, diphenylmethane 2,2′-, 2,4′-, and/or 4,4′-diisocyanate (MDI), 1,5-naphthylene diisocyanate (NDI), tolylene 2,4- and/or 2,6-diisocyanate (TDI), diphenylmethane diisocyanate, 3,3′-dimethyldiphenyl diisocyanate, 1,2-diphenyl-ethane diisocyanate and/or phenylene diisocyanate. Particular preference is given to use of 4,4′-MDI.
b) Compounds (b) which are reactive toward isocyanates and which may be used are the well-known compounds reactive toward isocyanates, for example polyesterols, polyetherols, and/or polycarbonatediols, these usually also being brought together under the term “polyols”, with molar masses of from 500 to 8000, preferably from 600 to 5000, in particular from 800 to 3000, and preferably with an average functionality of from 1.8 to 2.3, preferably from 1.9 to 2.2, in particular 2. The compounds (b) preferably have only primary hydroxy groups.
c) Chain extenders (c) which may be used are well-known aliphatic, araliphatic, aromatic and/or cycloaliphatic compounds with a molar mass of from 50 to 499, preferably bifunctional compounds, for example diamines and/or alkanediols having from 2 to 10 carbon atoms in the alkylene radical, in particular 1,4-butane-diol, 1,6-hexanediol, and/or di-, tri-, tetra-, penta-, hexa-, hepta-, octa-, nona-, and/or decaalkylene glycols having from 3 to 8 carbon atoms, and preferably corresponding oligo- and/or polypropylene glycols. Mixtures of the chain extenders may also be used here. The compounds (c) preferably have only primary hydroxy groups.
d) Suitable catalysts which in particular accelerate the reaction between the NCO groups of the diisocyanates (a) and the hydroxy groups of the structural components (b) and (c) are the known and conventional tertiary amines of the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane, and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like. The amounts usually used of the catalysts are from 0.0001 to 0.1 part by weight per 100 parts by weight of polyhydroxy compound (b). It is preferable to use tin catalysts, in particular stannous dioctoate.
e) Besides catalysts (d), other materials which may be added to the structural components (a) to (c), alongside the inventive plasticizers (i), are conventional auxiliaries (e). By way of example, mention may be made of surface-active substances, flame retardants, nucleating agents, antioxidants, lubricants, and mold-release agents, dyes, and pigments, stabilizers e.g. with respect to hydrolysis, light, heat, or discoloration, inorganic and/or organic fillers and reinforcing agents. Hydrolysis stabilizers used are preferably oligomeric and/or polymeric aliphatic or aromatic carbodiimides. Stabilizers may preferably be added to the inventive TPUs to stabilize them with respect to aging. For the purposes of the present invention, stabilizers are additives which protect a plastic or a plastic mixture from adverse effects of the environment. Examples are primary and secondary antioxidants, hindered amine light stabilizers, UV absorbers, hydrolysis stabilizers, quenchers, and flame retardants. Examples of commercially available stabilizers are given in Plastics Additive Handbook, 5th Edition, H. Zweifel, ed., Hanser Publishers, Munich, 2001 ([1]), pp. 98-136.

If the inventive TPU is exposed to thermo-oxidative degradation during its use, antioxidants may be added. It is preferable to use phenolic antioxidants. Examples of phenolic antioxidants are given in Plastics Additive Handbook, 5th edition, H. Zweifel, ed., Hanser Publishers, Munich, 2001, pp. 98-107 and pp. 116-121.

Preference is given to phenolic antioxidants whose molar mass is greater than 700 g/mol. An example of a phenolic antioxidant whose use is preferred is pentaerythrityl tetrakis(3-(3,5-bis(1,1-dimethylethyl)-4-hydroxyphenyl)propionate) (Irganox® 1010). The concentrations used of the phenolic antioxidants are generally from 0.1 to 5% by weight, preferably from 0.1-2% by weight, in particular from 0.5-1.5% by weight.

TPUs exposed to UV light are preferably also stabilized with a UV absorber. UV absorbers are well known and are molecules which absorb high-energy UV light and dissipate the energy. Familiar UV absorbers used in industry come, by way of example, from the group of the cinnamic esters, the diphenylcyanoacrylates, the formamidines, the benzylidenemalonates, the diarylbutadienes, the triazines, and the benzotriazoles. Examples of commercially available UV absorbers are found in Plastics Additives Handbook, 5th edition, H. Zweifel, ed., Hanser Publishers, Munich, 2001, pp. 116-122.

In one preferred embodiment, the UV absorbers have a number-average molar mass greater than 300 g/mol, in particular greater than 390 g/mol. The molar mass of the UV absorbers whose use is preferred should moreover not be greater than 5000 g/mol, particularly preferably not greater than 2000 g/mol.

Particularly suitable UV absorbers are the benzotriazoles group. Examples of particularly suitable benzotriazoles are Tinuvin® 213, Tinuvin® 328, Tinuvin® 571, and Tinuvin® 384, and Eversorb® 82. The amounts usually added of the UV absorbers are from 0.01 to 5% by weight, based on the total weight of TPU, preferably from 0.1 to 2.0% by weight, in particular from 0.2 to 0.5% by weight.

A UV stabilizer system described above, based on an antioxidant and a UV absorber, is often still not sufficient to ensure that the inventive TPU has good resistance to the damaging effect of UV radiation. In this case, a hindered amine light stabilizer (HALS) may be added to the inventive TPU, in addition to the antioxidant and to the UV absorber. The activity of HALS compounds is based on their ability to form nitroxyl radicals which intervene in the mechanism of oxidation of polymers. HALS are highly efficient UV stabilizers for most polymers.

HALS compounds are well known and are available commercially. Examples of commercially available HALS stabilizers are found in Plastics Additive Handbook, 5th edition, H. Zweifel, Hanser Publishers, Munich, 2001, pp. 123-136. Preferred hindered amine light stabilizers are those whose number-average molar mass is greater than 500 g/mol. The molar mass of the preferred HALS compounds should moreover not be greater than 10 000 g/mol, particularly preferably not greater than 5000 g/mol. Particularly preferred hindered amine light stabilizers are bis(1,2,2,6,6-pentamethylpiperidyl) sebacate (Tinuvin® 765, Ciba Spezialitätenchemie AG) and the condensate of 1-hydroxyethyl-2,2,6,6-tetramethyl-4-hydroxypiperidine and succinic acid (Tinuvin® 622). Particular preference is given to the condensate of 1-hydroxyethyl-2,2,6,6-tetramethyl-4-hydroxypiperidine and succinic acid (Tinuvin® 622) if the titanium content of the product is <150 ppm, preferably <50 ppm, in particular <10 ppm. HALS compounds are preferably used at a concentration of from 0.01 to 5% by weight, particularly preferably from 0.1 to 1% by weight, in particular from 0.15 to 0.3% by weight.

One particularly preferred UV stabilizer system comprises a mixture composed of a phenolic stabilizer, of a benzotriazole, and of a HALS compound, in the preferred amounts described above.

Further information concerning the abovementioned auxiliaries and additives can be found in the technical literature, e.g. from Plastics Additive Handbook, 5th edition, H. Zweifel, ed., Hanser Publishers, Munich, 2001.

All of the molar masses mentioned in this specification have the unit [g/mol]. To adjust hardness of the TPUs, the molar ratios of the structural components (b) and (c) may be varied relatively widely. Molar ratios which have proven successful between component (b) and the entire amount of chain extenders (c) to be used are from 10:1 to 1:10, in particular from 1:1 to 1:4, the hardness of the TPUs rising as content of (c) increases. The reaction may take place at conventional indices, preferably at an index of from 60 to 120, particularly preferably at an index of from 80 to 110. The index is defined via the ratio of the total number of isocyanate groups used during the reaction in component (a) to the groups reactive toward isocyanates, i.e. the active hydrogens, in components (b) and (c). If the index is 100, there is one active hydrogen atom, i.e. one function reactive toward isocyanates, in components (b) and (c) for each isocyanate group in component (a). If the index is above 100, there are more isocyanate groups present than OH groups. The TPUs may be prepared by the known processes continuously, for example using reactive extruders or the belt process by the one-shot method or prepolymer method, or batchwise by the known prepolymer process. In these processes, components (a), (b), and, if appropriate, (c), (d), and/or (e) to be reacted are mixed with one another in succession or simultaneously, whereupon the reaction begins immediately. In the extruder process, structural components (a), (b), and also, if appropriate, (c), (d), and/or (e) are introduced, individually or as a mixture, into the extruder, and reacted, e.g. at temperatures of from 100 to 280° C., preferably from 140 to 250° C., and the resultant TPU is extruded, cooled, and pelletized. Conventional processes, e.g. injection molding or extrusion, are used to process the TPUs of the invention, comprising the plasticizers of the invention, these usually being in the form of pellets or powder, to give the desired films, moldings, rollers, fibers, coverings within automobiles, tubing, cable plugs, folding bellows, drag cables, cable sheathing, gaskets, drive belts, or attenuating elements. The thermoplastic polyurethanes which can be produced by the inventive processes, preferably the films, moldings, shoe soles, rollers, fibers, coverings within automobiles, wiper blades, tubing, cable plugs, folding bellows, drag cables, cable sheathing, gaskets, drive belts, or attenuating elements, have the advantages described at the outset.

### EXAMPLES

### Example 1

59 parts by weight of polymer diol based on 1,4-butanediol and/or 1,2-ethylene glycol and adipic acid with number-average molar mass of about 2000 g/mol were reacted in a reaction extruder with 4.7 parts by weight of 1,4-butanediol and 21 parts by weight of diphenylmethylene 4,4′-diisocyanate, and also with various additives, such as hydrolysis stabilizer, other stabilizers, and lubricant, and 15 parts by weight of inventive plasticizers were metered in prior to pelletization. The Shore hardness of the resultant TPU was about 70 A, and it could be processed for example by way of extruders to give profiles and tubing, or else by injection molding to give shoe soles and other moldings.

### Example 2

20 parts by weight of the inventive plasticizer were incorporated in a twin-screw extruder into 80 parts by weight of TPU whose Shore hardness was about 80 A. The TPU thus prepared was used in an injection-molding machine to produce moldings whose Shore hardness was 70 A.

1-15. (canceled)

16. A thermoplastic comprising plasticizer (i), wherein the plasticizer (i) is an ester based on polytetrahydrofuran and on a monocarboxylic acid, selected from benzoic acid and acetic acid.

17. The thermoplastic polyurethane according to claim 16, wherein the molar mass of the plasticizer (i) is from 300 g/mol to 4500 g/mol.

18. The thermoplastic polyurethane according to claim 16, wherein the plasticizer (i) has the following structural formula:
H₅C₆—CO—O—[(CH₂)₄—O]ₙ—CO—C₆H₅
where n is a whole number from the range from 2 to 50.

19. The thermoplastic polyurethane according to claim 16, wherein the plasticizer (i) is liquid at 25° C. and at a pressure of 1 bar.

20. The thermoplastic polyurethane according to claim 16, wherein the number-average molar mass of the plasticizer (i) is smaller than the weight-average molar mass of the plasticizer (i).

21. The thermoplastic polyurethane according to claim 16, wherein the hydroxy number of the plasticizer (i) is smaller than 25 mg KOH/g.

22. The thermoplastic polyurethane according to claim 16, wherein the acid number of the plasticizer (i) is smaller than 10.

23. The thermoplastic polyurethane according to claim 16, wherein the haze number of the intrinsic color of the plasticizer (i) is smaller than 200.

24. The thermoplastic polyurethane according to claim 16, wherein the alkali metal content of the plasticizer (i) is smaller than 500 ppm.

25. The thermoplastic polyurethane according to claim 16, wherein the water content of the plasticizer (i) is smaller than 0.2% by weight.

26. The thermoplastic polyurethane according to claim 16, wherein the amount present of the plasticizer (i) in the thermoplastic is from 1 to 70% by weight, based on the total weight of the thermoplastic comprising the plasticizer (i).

27. The thermoplastic polyurethane according to claim 16, whose Shore hardness is from 40 A to 95 A.

28. A process for the production of thermoplastic polyurethanes, which comprises adding, to the thermoplastic polyurethane, during and/or after the production process, plasticizer according to claim 16.
